(19) United States
(12) Patent Application Publication
(10) Pub. No.: US 2013/0166386 A1
(43) Pub. Date: Jun. 27, 2013

(54) COMMUNITY-BASED MARKETING AND ADVERTISING APPLICATION

(71) Applicant: Christopher Simmons, Alexandria, VA (US)

(72) Inventor: Christopher Simmons, Alexandria, VA (US)

(21) Appl. No.: 13/759,602

(22) Filed: Feb. 5, 2013

Related U.S. Application Data
(63) Continuation-in-part of application No. 13/723,102, filed on Dec. 20, 2012, now abandoned.
(60) Provisional application No. 61/578,325, filed on Dec. 21, 2011.

(51) Int. Cl. G06Q 30/02; H04W 4/02

(52) U.S. Cl. CPC G06Q 30/0261
USPC 705/14.58

(57) ABSTRACT

A community-based marketing and advertising service uses an application (“app”) that is configured to provide location-aware services to promote local businesses and show the character and/or history of the location to customers and visitors who use the app. The app may be implemented on diverse computing platforms as both web- and smartphone-based products having location-awareness capabilities provided, for example, by GPS (Global Positioning System) or mobile phone tracking technologies such as cell tower triangulation. The app is implemented in a manner to readily enable businesses to market and advertise using, for example, social networking constructs such as blogging and tweeting while simultaneously providing users with easy-to-use tools to plan a visit, navigate and receive directions in real time using maps displayed by the app, receive promotional offers such as coupons, and generate feedback for the benefit of other users while at or near a given location in the community.

### BACKGROUND

Location-based services typically may be utilized to provide users of mobile devices such as smartphones, tablets, mobile PCs (personal computers), and similar devices with a wide variety of experiences and features. However, a need exists for a platform that allows for easily-consumable content and information to be delivered to consumers that is more particularly tailored to the local community.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

A community-based marketing and advertising service uses a mobile application (“app”) that is configured to provide location-aware services to promote local businesses and show the character and/or history of the local community to customers and visitors who use the mobile app. The mobile app may be implemented on diverse computing platforms as both web- and smartphone-based products having location-awareness capabilities provided, for example, by GPS (Global Positioning System) or mobile phone tracking technologies such as cell tower triangulation. The mobile app is implemented in a manner to readily enable businesses to market and advertise, push offers such as mobile coupons that can be tailored to the user, and utilize a variety of social networking constructs such as blogging and tweeting. The mobile app simultaneously provides users with easy-to-use ways to readily discover rich content pertaining to the local community, plan a visit, navigate and receive directions in real time using maps displayed by the mobile app, receive promotional offers such as coupons, learn of current and upcoming local events while at or near a given location in the community, and generate feedback for the benefit of other users.

Mobile app users (e.g., tourists/shoppers) can choose to have the mobile app configured and operated on a custom or individualized basis so that the presented information and the local experiences enabled by the mobile app are relevant, interesting, and compelling to the users. And while the mobile app's features support trip planning and research into a local community at any time, no pre-planning or work in advance is necessary for mobile app users to fully benefit from the mobile app's features during a visit to the local community. Users can simply launch the mobile app at the start of the visit and, without having to do more, receive interesting and relevant information, offers, and insights into the local community that are delivered based on the user's profile/preferences/observed behaviors and activities, and proximity to a business or other point of interest in the local community. As the user's trip through the community progresses, and the user's location changes and time passes, relevant and timely information will be continuously pushed to the mobile app from the service so that the user is kept up to date about available activities and opportunities. For example, a mobile app user passing near a restaurant at noon can be provided with a mobile coupon for a discount on lunch. And while returning from a play at a community theater and passing by a florist in the local community, the user can be presented with a reminder and mobile coupon to purchase flowers for the user's wedding anniversary dinner planned for later that evening.

Using tools provided by the present service, businesses can build detailed, salient, and easily consumable content about the community that is delivered on a hyper-local basis, block-by-block, which provides a more immersive, comprehensive, and enjoyable travel/shopping/sightseeing/dining experience to the mobile app user. The service can further expose resources to the businesses so that they can more easily work together to promote the particular characteristics and charms of their local community. Certain data collected from the user-generated profile and from the mobile app user's observed behaviors and activities may be provided to the businesses from the service in real time or on an accumulated basis. In this way, anonymized information about their customers' preferences and consumption behaviors are provided to the businesses as a way for them to access robust analytics and demographic data to better enable them to promote their goods/services offerings and build more effective relationships with their customers.

Illustratively, businesses may configure the service to notify them, for example using an e-mail, voicemail, instant message, or text message each time a mobile coupon is delivered to a user who travels within a pre-defined proximity of the business. Or, for example a business may elect to receive a monthly report from the service that indicates the amount of traffic passing the storefront and at what times, the number of offers that were delivered and read by users and redeemed/not redeemed, the user's itinerary within the local community, their frequency of visits to the community, purchasing histories at the local businesses, demographic information about the user, and the like, all on an anonymized basis.

Users can sign up for the service for free (or on a fee-based or subscription basis) at a website that is associated with the mobile app (or using the mobile app itself when downloaded to a user's device and started), provide an e-mail address and background information, set mobile app preferences, and provide profile and demographic information and/or other data pursuant to disclosed privacy and usage agreements that the user can read and then opt into, in typical implementations. The usage agreement may call for the anonymized data collection from the user where the collected data typically describes the user's behaviors and activities while using the mobile app within the local community. The user can download the mobile app on a free or fee basis to his/her smartphone, tablet computer, or similar device from the website or other linked resource such as a web page or Twitter® feed.

Once the user has signed up and logs into the service, using the mobile app executing on the smartphone, the user can navigate with a dynamically updated street map of the local community which highlights businesses and points of interest. The mobile app also makes it easy for the user to make travel plans; contact businesses in the community; make reservations for dining and entertainment; read the blogs and tweets of the local businesses; comment on the experiences in the community; learn about local points of interest and current and upcoming local events; and receive offers, coupons, advertising, and promotional materials from businesses in the community.

In some implementations, the service can provide businesses with an ability to push out messages and offers to the user via the mobile app that are specifically tailored to targeted users based on the user's profile. Observed past behaviors and activities of the user when using the mobile app, such as the user's coupon redemption history, travel itinerary within the local community, and/or purchase histories at various businesses, may also be used to tailor the information pushed to a targeted user via the mobile app. The tailoring of the information to targeted users may also take into account dynamic, historical, and other factors such as time of day, day of week, season, proximity of the user to a particular business or location in the community, behaviors and activities of other users with similar profile/demographics, events occurring in the community, and the like. Tools may also be exposed to the business to configure the service to push out appropriate messages and offers automatically when certain criteria are met (e.g., users conforming to a certain demographic are within a certain, pre-defined proximity of the business), or the merchant can choose to push out messages and offers manually (e.g., offer a discount coupon to customers within a certain proximity of the business to help sell excess perishable grocery items before the end of the day).

Advantageously, the present service and mobile app can leverage location-aware smartphone and other small factor computing technologies to help local businesses to promote themselves. For example, the existing GPS features enabled in such platforms can be utilized by the service and mobile app to provide tourists/shoppers with an easier way to navigate where to shop and dine by receiving real time directions, promotions, and store information based on their proximity to the businesses and other locations in a given local community. The mobile app further enables users to take pre-planned trips into the local community as well as take advantage of serendipitous discovery of opportunities and activities once in the community. Using the service, local businesses in the community are better able to advertise their services on the widely popular mobile computing platforms such as smartphones while focusing on mobile app users who are actually in the area and thus able to act immediately upon the pushed information and offers. The service acts as an intermediary between the users and businesses to triangulate data from tourist/shopping experiences to the businesses. This data can help enable the businesses to work together to promote unique aspects or features of their particular local community.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 shows an illustrative location-based services environment that facilitates practice of the present community-based service and mobile app;

FIG. 2 shows an illustrative functional architecture of a web-based mobile app or native mobile app that can implement the functionalities provided by the present service on a local client device;

FIG. 3 shows an illustrative target deployment area containing a number of businesses that is subdivided into separate communities;

FIGS. 4 and 5 are illustrative screen shots of a user interface of the present mobile app that shows a dynamically updated street map of businesses within a local community;

FIG. 6 shows an illustrative taxonomy of functionalities that may be exposed by the service provider in typical implementations of the present service and mobile app;

FIG. 7 is a flowchart showing methods that may be employed in a consumer user interface;

FIG. 8 is a flowchart showing methods that may be employed in a merchant user interface;

FIG. 9 shows an illustrative arrangement in which various service packages arranged in tiers may be established between the service provider and local businesses; and

FIG. 10 shows an illustrative simplified block diagram of a mobile device on which a mobile app may run.

Like reference numerals indicate like elements in the drawings. Elements are not drawn to scale unless otherwise indicated.

### DETAILED DESCRIPTION

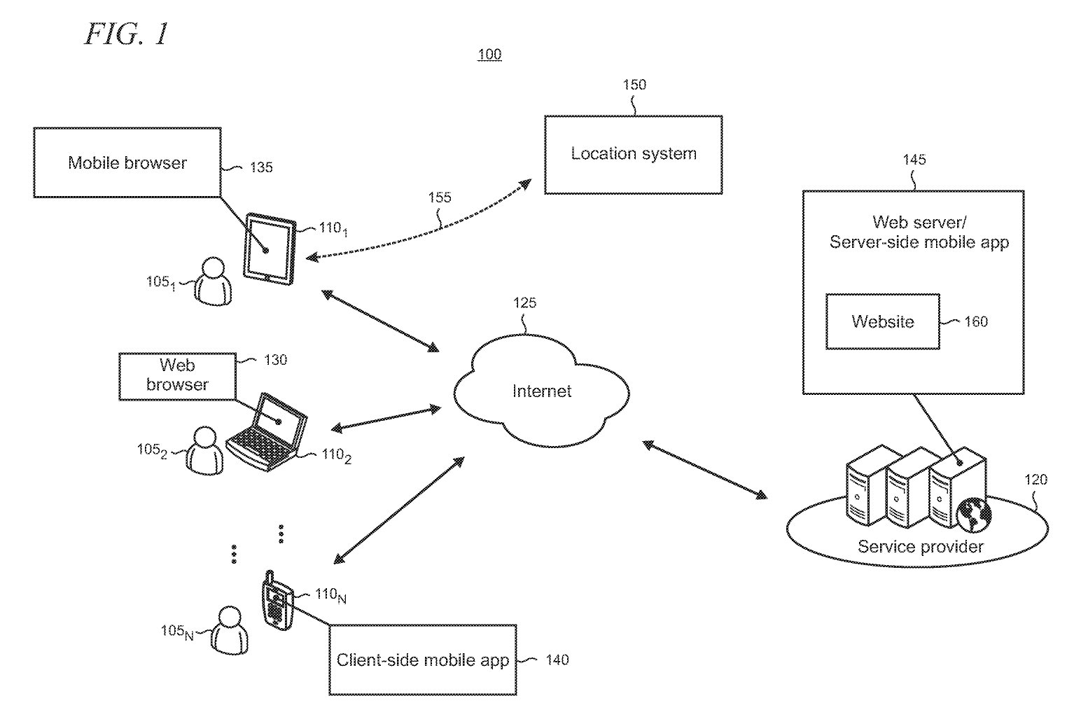

FIG. 1 shows an illustrative location-based services environment 100 that facilitates practice of the present community-based service and app. Users 105 of various computing devices 110 including, for example, notebook PCs (personal computers), Internet-enabled mobile phones, smartphones, tablet computers, and the like communicate with a community-based marketing and advertising service provider 120 over a network which typically includes the Internet 125 (it is noted that the terms “service” and “service provider” may be used interchangeably in the discussion that follows). While the present service and app can be supported on many different types of computing platforms, in many typical applications the devices include battery powered mobile devices that the users 105 can utilize while on the go out in the community.

The present mobile app can be instantiated on the various computing devices 110 in different ways. For example, the mobile app can be web-based which typically uses a browser (for example, web browser 130 or mobile browser 135 in FIG. 1) to execute code provided by servers utilized by the service provider 120. Alternatively, the mobile app can be implemented as a native app (for example, client-side mobile app 140 in FIG. 1) on a device in which code executes locally.

In both cases—native and web-based—local code execution is typically combined with some server-side code execution and/or data provision in order to provide the app features and user experience described herein. This server-side functionality is collectively indicated by reference numeral 145 in FIG. 1. However, in some instances, the mobile app may execute substantially completely locally and may be further configured to fetch and store data from the service provider 120. This latter configuration may be utilized when a particular device does not have capability to directly access the service provider 120 and relies, for example, on data communication when docked or otherwise coupled to some other Internet-enabled device. Unless otherwise indicated, the mobile app 140 will be used for purposes of describing the various illustrative examples that follow.

The computing devices 110 may also operatively connect to a remote location system 150 or other facility so that the mobile app 140 can utilize location-awareness to provide the present features and user experience. The operative connection is representatively indicated between device 110₁ and the location system by line 155. For many devices which are equipped with GPS receivers, the location system 150 will comprise a GPS satellite system. However, various other types of location systems that are known in the art such as cell tower triangulation methods, or combinations of such conventional systems and methods, may also be used.

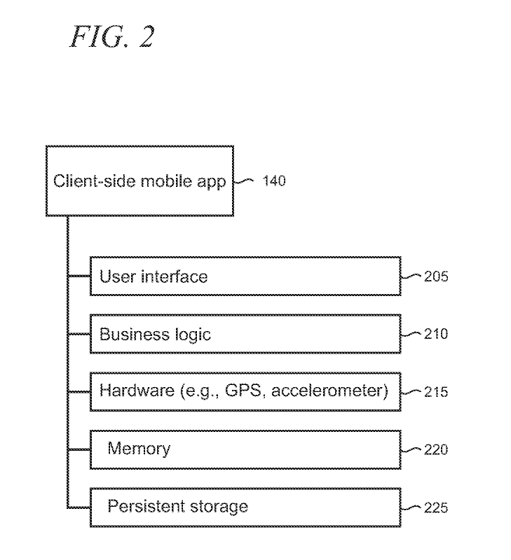

FIG. 2 shows a typical functional architecture of the mobile app 140. It is noted that a web-based app would have similar features. The mobile app 140 typically includes functionality that is implemented using computer-readable code directed to a user interface 205. Code implementing the business logic 210 of the app 140 is also included. The mobile app 140 will also typically include code that implements interfaces to various hardware features 215 in a device 110 (e.g., the GPS and/or accelerometer used for location-awareness) as well as memory 220 and persistent storage 225.

The present service 120 and mobile app 140 are next described in the context of a deployment scenario in an exemplary historic city center of Alexandria, Va., USA which is commonly referred to as “Old Town”. In this scenario, the service can be branded as “WhenIn-Alexandria.com” which also provides the URL (Uniform Resource Locator) of a website 160 (FIG. 1) that is supported by the service 120. The WhenIn-Alexandria.com website 160 can typically be operated on a standalone basis with a conventional PC or mobile browser or be supplemented by the mobile app 140. However, in some cases where the mobile app 140 is the primary platform to support the present feature and user experience, the website 160 may be configured to provide supplemental information to the mobile app 140 or be used by users to sign up with the service and download the mobile app 140. It will be appreciated that other services can be offered in other cities worldwide using similar branding if desired such as WhenIn-NewYork.com, or WhenIn-London.com, etc. Alternatively, the other service offerings may be configured to be accessible from a single website that operates, for example, as a portal to most or all of the “WhenIn-” locations.

In some applications, the website 160 may also be configured to provide separate functionality to end users (e.g., visitors to Alexandria who use the website 160 and/or mobile app 140) and to businesses that are using the service 120 to feature their particular goods and services. For example, the service provider 120 may enable the website 160 to expose online tools to the businesses to manage their account with the service, upload content to the service for sharing with the users 105 (such as weblogs (“blogs”) and tweets under the Twitter service as described below), and the like.

For the purposes of organizing the service 120, in many typical implementations the target deployment area is divided into a number of communities. Depending on the needs of a particular implementation, the communities can be discrete or they may overlap. Dividing the target deployment area into separate communities can be expected to allow the businesses to work together to promote the interests of their particular community. The number and types of criteria used to define each community may vary by implementation and can include geographic characteristics, languages spoken, cultural and socio-demographic factors, number and types of businesses (e.g., shopping, dining, entertainment, personal services, financial, etc.) in the area, residential/commercial mix, and the like. Dividing the larger target deployment area into a group of smaller sized communities may also enable the mapping and navigation features to be more seamlessly implemented in some cases, for example, by reducing the memory footprint for map storage and/or retrieval from the service 120.

Such focus on relatively small, discrete, identifiable local communities, termed here as a “hyperlocal” focus, may also be expected to enhance the experiences of mobile app users, in some implementations, by breaking down larger geographic areas into manageable regions. Such small local communities are easier for users to comprehend and manage so that the provided content, which can often be richly detailed in typical implementations, does not become overwhelming. In addition, the mobile app users can benefit because the real time information and offers can typically be immediately consumed. For example, when a mobile app user travels past a store and receives a mobile coupon for a special deal on an item, the user knows that the deal can be taken advantage of right then because the store is right there, it is open, and the special item is in stock. In cases where the user is specifically targeted, the user could also know that the special item is stocked in the user's size and color choice. Businesses in the local community may reap benefits from a hyperlocal focus because they do not have to run national ad campaigns to get customer attention and reach specifically targeted users.

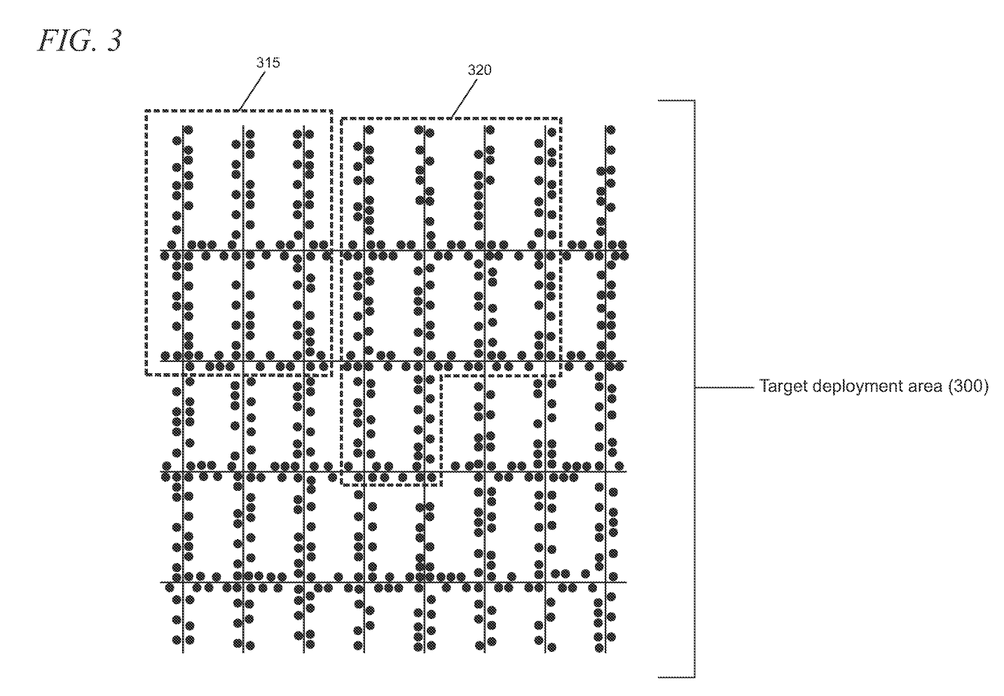

FIG. 3 shows an illustrative target deployment area 300 containing a number of businesses (shown by dots) that is subdivided into separate communities, as representatively indicated by reference numerals 315 and 320. The communities 315 and 320 are arbitrarily shaped and other communities (not shown) may also be contained in the target deployment area 300. Each community is presentable as a map to a user 105 (FIG. 1) displayed by the user interface of the mobile app 140 on the device 110. In the illustrative example of the WhenIn-Alexandria.com map, the mapped service area for Old Town Alexandria may be divided into ten communities with each community including ten one-block city streets that are connected geographically. Each city street includes approximately 15 businesses per street (for example, the 100 block of King Street has 18 businesses). Accordingly, each WhenIn-Alexandria.com community has approximately 150 businesses. It is emphasized that each community is not necessarily a ten square block area, but rather a central grouping of businesses that will work together with the service 120. It is further noted that the ten communities used in this particular scenario are merely illustrative and that a number of communities other than ten, or a single community, may be used as needed to meet the needs of a given implementation.

In one illustrative example, both the website 160 and the mobile app 140 are configured to provide substantially equivalent functionalities by supporting, for example, a comprehensive street-by-street moving map that highlights shopping and dining opportunities, supports a calendar, and supplies directions, and local history/local interest spots in each community of approximately 10 blocks in the target deployment area. The service 120 also offers individual businesses in the ten-block communities the opportunity to blog and tweet about their products/services which the app 140 can display to a device user 105. The businesses can also interact with tools offering real time coupons, promotions, and other enticements to consumers on site via their smartphones and other client devices.

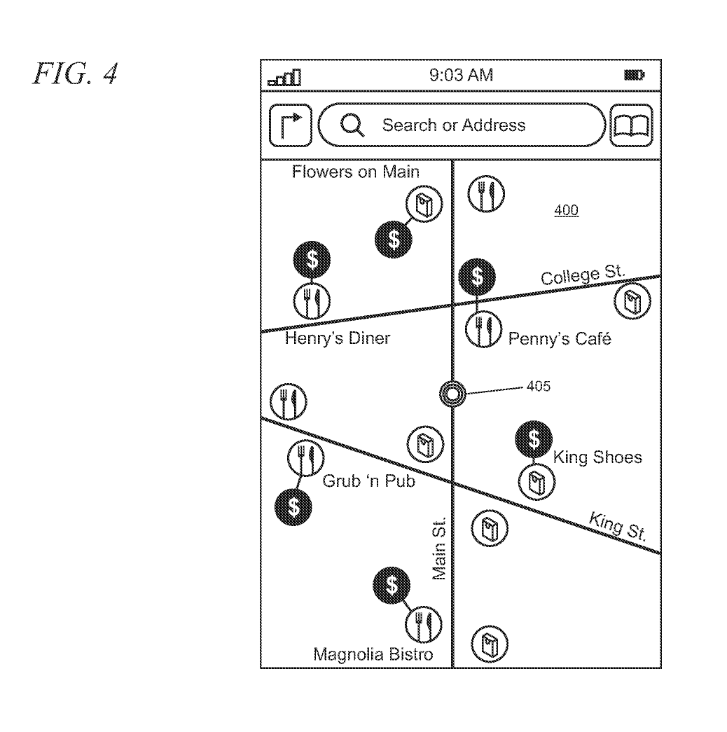

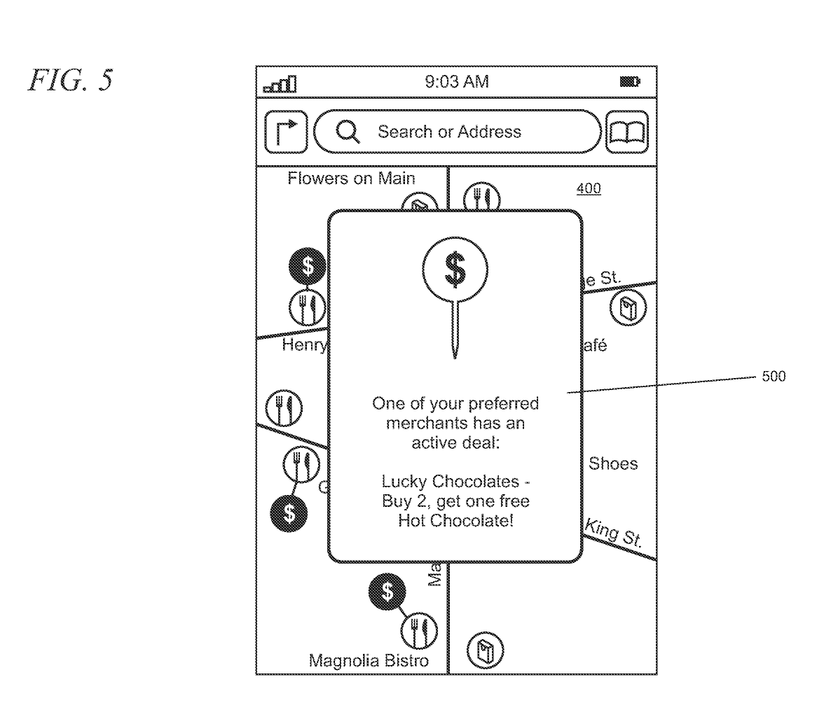

FIGS. 4 and 5 are illustrative screen shots of a user interface of the mobile app 140 (FIG. 1) that shows a dynamically updated street map 400 of businesses within a local community. The mobile app 140 shows the location of the user with an icon 405 and will continuously update the location of the user as the user moves throughout the local community. As shown in FIG. 4, the mobile app 140 shows deals being presently offered by merchants. In typical implementations, the user can set the radius from the user's current location within which the active offers will be displayed. The active offers can also be filtered against user-defined criteria so that only certain offers will be shown on the user interface of the mobile app. For example, a user may not wish to receive offers from non-vegetarian restaurants and can set filtering criteria in his/her profile or preferences so that such offers are not displayed by the mobile app 140. Other filtering criteria could include, for example, the type of deal and the amount of discount being offered. FIG. 5 shows an illustrative notification 500 that may be displayed on the user interface of the mobile app 140. In this example, the user has set a preference in the mobile app so that when a particular merchant has a deal, the user will be notified.

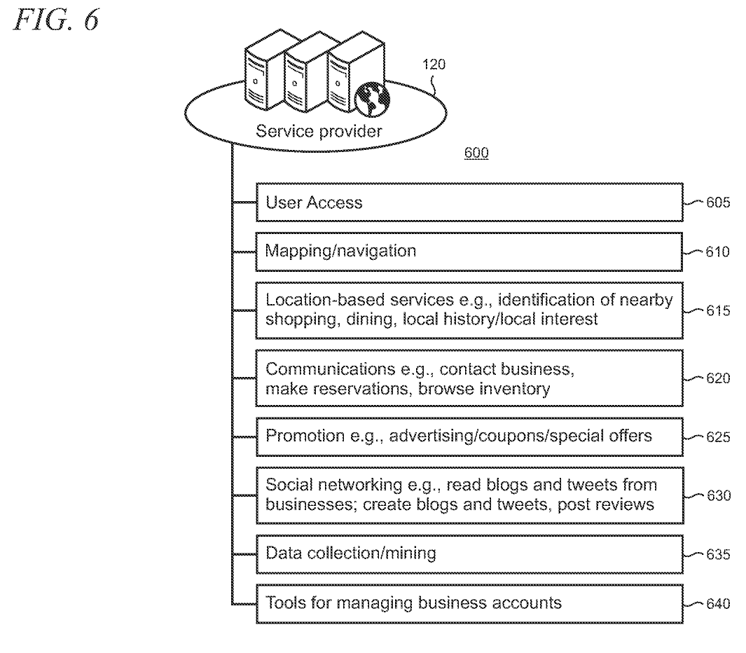

More specific features exposed by the app 140 are shown in FIG. 6 which depicts an illustrative taxonomy 600 of functionalities that may be exposed by the service provider 120 in typical implementations of the present service and app. As noted above, some of the functionalities included in the taxonomy may be implemented locally on a client device 110 via the mobile app 140, or implementation may be split between the service 120 and the device 110. A user access function 605 is typically provided so that a user 105 can initially sign up and then log in to the service. Mapping and navigation functions 610 may be exposed through the user interface 205 (FIG. 2). A variety of location-based services 615 are also included in most typical implementations. Illustrative examples include the identification of nearby shopping and dining opportunities and places of interest or historical significance in the community. Such identification is typically dynamic so that new businesses and places are continuously updated on the user interface as the mobile app user moves through the community.

Various communication functionalities 620 are supported so that the user can contact a business in the community via message (e.g., e-mail, instant message, text message, voicemail, and the like), make dining or show reservations, browse the businesses' product inventories, and the like. The businesses can promote their products and services via a promotion functionality 625 in which advertisements, coupons, and special offers can be viewed by the user. Social networking functionality 630 is supported so that users can read various blogs and tweets created by businesses in the community as well as generate their own blogs and tweets in some cases, or post reviews of a business for other users to see.

Data collection and data mining functionality 635 is also supported. Typically the users are given an opportunity to consent to certain types of data being collected and shared about their usage of the service with the businesses in the community. Profile data that users input when they sign up to the service can also be shared in some cases. Generally, the shared data is anonymized so that no personally identifiable information about any given user is revealed to any business so that users' privacy is not compromised in any way. As noted above, the service 120 may also maintain a comprehensive set of tools 640 that are exposed to the businesses so that they can manage their accounts with the service.

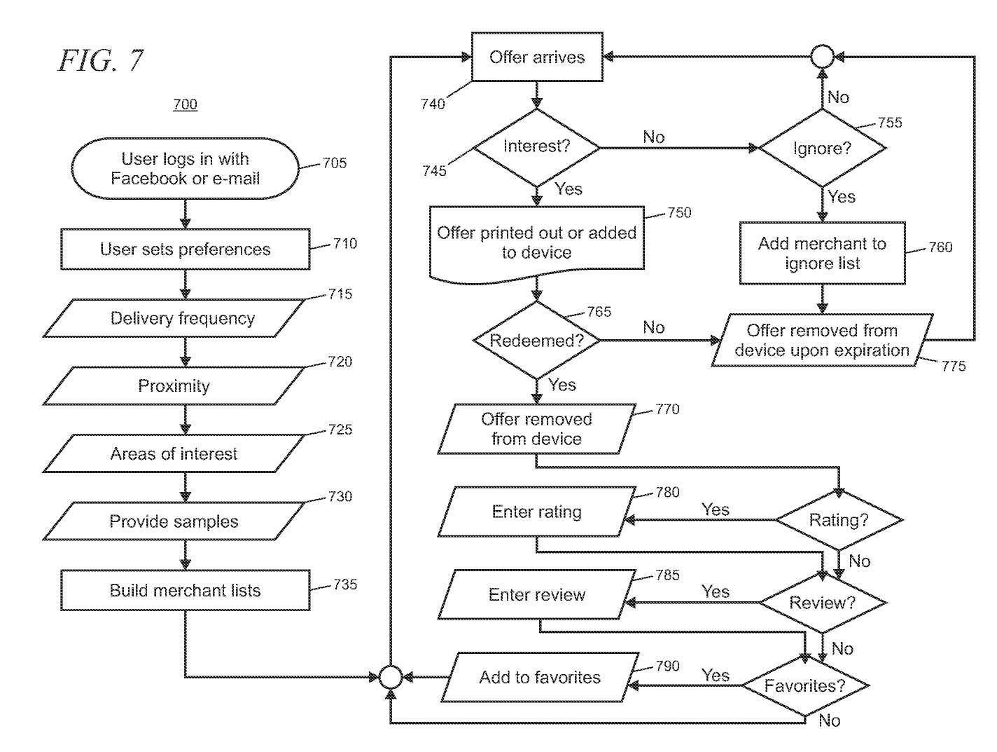

FIG. 7 is a flowchart 700 showing methods that may be employed in a user interface that may be exposed by the website 160 (FIG. 1) and/or mobile app 140 to the mobile app user. The user typically starts (as indicated by block 705) by logging in with an e-mail address or using an existing identity, for example one provided by a social networking service such as Facebook®. Once logged in, the user can set preferences (block 710) which may illustratively include the frequency at which offers may be delivered by businesses to the mobile app 140 (block 715), the proximity to the business within which the user must be located before an offer is delivered (block 720), and areas/topics/subjects of interest to the user (block 725).

The user may also provide samples of businesses that the user does like and have interest in (block 730). In this case, the service can use various matching algorithms to match the provided sample businesses against other similar businesses that are likely to also be liked by the user. Such matching can help to populate a larger and more comprehensive list of merchants and businesses in the local community that are available to participate in the present service (block 735).

During operation of the mobile app 140 in the local community, when an offer from a business arrives at the mobile app (block 740) the user can decide (block 745) if the offer is of interest or not. If the offer is of interest, then it can either be printed or locally stored by the mobile app 140 on the device 110 (block 750) as a mobile coupon. In the latter case, a user can typically show the device displaying the mobile coupon to the merchant for redemption. In some cases redemption may be performed via a scannable bar code in the coupon or using similar techniques.

If the offer is not of interest to the user, then the user may be given an option to ignore the offer (block 755) and add the merchant who sent the uninteresting offer to an ignore list (block 760). In some implementations, data pertaining to the user's interest and disinterest in various offers can be tracked to help refine the offers provided to the user and/or to provide offer performance data back to the service or the businesses in the local community. If the offer is redeemed (block 765), then the offer is removed from the mobile app 140 and device 110 (block 770), otherwise the offer will typically be stored by the mobile app and device until the offer expires (block 775) or is otherwise removed by either the user or service.

The user will typically be provided with an opportunity to input a rating and review of the business that provided the offer (blocks 780 and 785, respectively). The ratings and reviews can be configured for viewing by other mobile app users, and in some cases via the website 160 for example, by people in the local community at large, even if they are not mobile app users or service subscribers. The user may also add a business to the user's list of favorites (block 790).

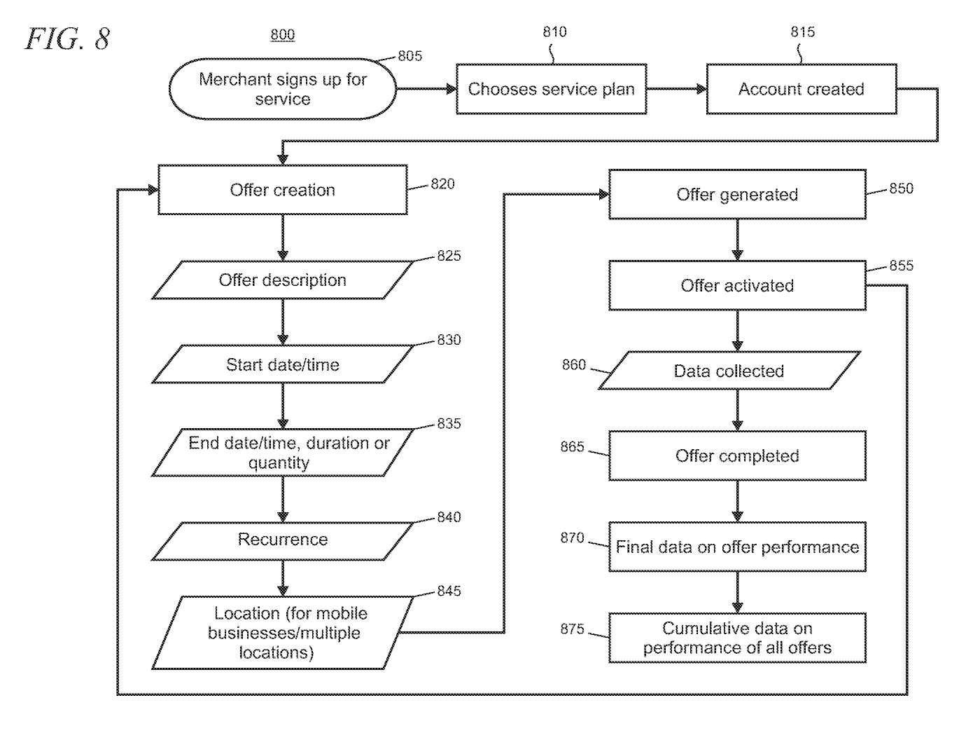

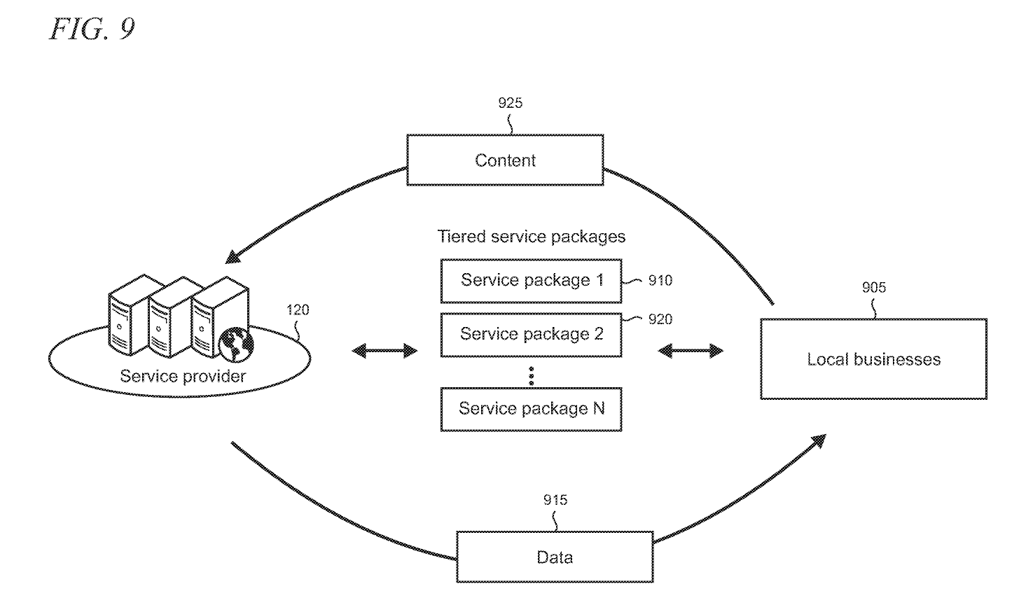

FIG. 8 is a flowchart 800 showing methods that may be employed in a merchant user interface, for example, as may be exposed by the service 120 (FIG. 1) via the website 160. Typically, a merchant signs up for the service (block 805) and then chooses a service plan (810) so that a merchant account can be created (815). Various types of service plan types may be utilized, including the illustrative arrangement shown in FIG. 9 and described in the accompanying text below. The service can expose tools for the merchant to create various offers, announcements, and notifications (block 820). The merchant can input a description of the offer (block 825), the start date and time for the offer (block 830), the ending date and time for the offer, offer duration (i.e., time period for redemption before offer expiration), and various other details, restrictions, and limitations such as limits on quantities, sizes, colors, etc. (block 835). The recurrence of the offer may also be set (block 840) as well as the location of the business (block 845) in cases where the business operates on a mobile basis or has multiple locations.

Responsively to the merchant input through the user interface, the offers are generated (block 850) and activated via delivery to the user mobile app 140 and device 110 (block 855). As described above, data regarding the user's behavior towards the offer (interested/disinterested/ignore/redeemed) can be collected (block 860) and the offer completed (block 865). Performance data about a given offer can typically be compiled, anonymized, and provided to the merchant (block 870) and cumulative data regarding all of a merchant's offers may also be compiled, anonymized, and reported (block 875). A range of analytical, statistical, historical, and comparative data may also be generated using the collected data from block 860.

FIG. 9 shows an illustrative arrangement in which various service packages arranged in a number of tiers may be established between the service provider 120 and local businesses 905. In one exemplary embodiment, a tier one service package 910 would be free to all businesses in given mapped communities in the target deployment area. The tier one, or basic service package, may provide a business listing on the community map which supports location identification via GPS functionality on a user's device, and the ability to get feedback/reviews from the service users via a data feed 915. The tier two service package 920 can be provided to businesses in the mapped community on a paid subscription or other fee basis.

This tier two service package may offer use of enhanced marketing tools to enable the businesses to blog and tweet and provide other content (collectively identified as “content” by reference numeral 925 in FIG. 9) on the website 160 and mobile app 140 and allow for virtual coupons and other promotions and advertising to be delivered to the users. The merchants may also be able to advertise on the site at a reduced rate and receive more comprehensive customer data in the data feed 915 that can be mined from use of the website 160.

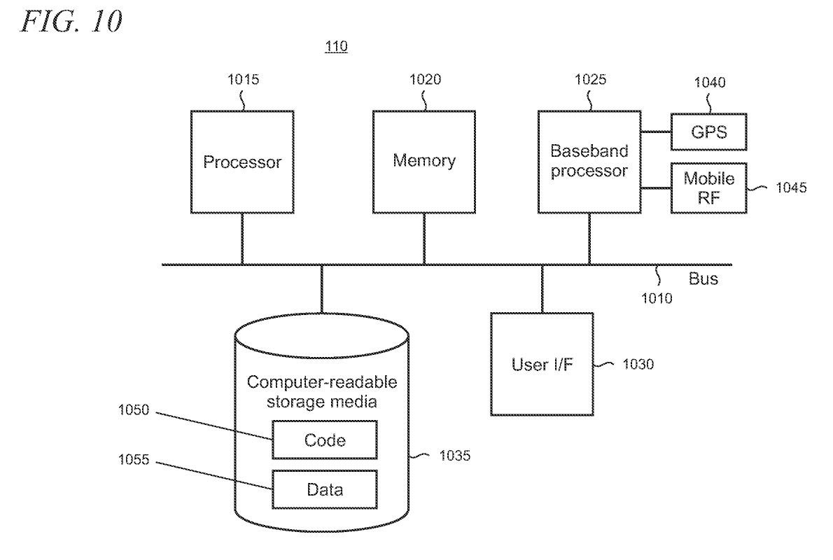

FIG. 10 shows an illustrative simplified block diagram of a mobile device, such as device 110 (FIG. 1), on which a mobile app may run, such as mobile app 140. A bus 1010 is used to operatively couple a variety of devices including a processor 1015, memory 1020, baseband processor 1025, user interface (I/F) 1030, and computer-readable storage media 1035. Not shown are other common components such as power supplies and various circuits such as timing sources, peripherals, analog-to-digital and digital-to-analog converters, voltage regulators, and power management circuits, and the like which are well known in the art, and therefore, will not be described any further. Coupled to the baseband processor are a GPS module 1040 and mobile RF (radio frequency) module 1045. The computer-readable storage media 1035 may be used, among other purposes, to store computer-executable instructions and code 1050 and data 1055.

Several aspects of mobile communications systems will now be presented with reference to various apparatus and methods described in the foregoing detailed description and illustrated in the accompanying drawing by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system. By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer- readable media. Computer-readable media may include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable media for storing or transmitting software. The computer-readable media may be resident in the processing system, external to the processing system, or distributed across multiple entities including the processing system. Computer-readable media may be embodied in a computer-program product. By way of example, a computer-program product may include a computer-readable media in packaging materials. Those skilled in the art will recognize how best to implement the described functionality presented throughout this disclosure depending on the particular application and the overall design constraints imposed on the overall system.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A computer-implemented method for providing a location-based service to a user of a computing device, the method comprising the steps of:
collecting data from a plurality of businesses, the data including locations of the businesses within a service area and descriptions of the businesses;
identifying one or more communities within the service area;
mapping the identified communities;
receiving, from the computing device, an indication of a geographic location of the user within a mapped community, the indication including a proximity of the user to a given location within the mapped community; and
transmitting instructions which, when executed on the computing device, facilitate displaying at least a portion of the collected data to the user via the user interface, the displaying being performed responsively to the proximity of the user to the given location.

2. The computer-implemented method of claim 1 further including a step of receiving user input via the user interface, the user input indicating at least a destination within the service area.

3. The computer-implemented method of claim 2 further including a step of determining a route to the destination.

4. The computer-implemented method of claim 3 further including a step of transmitting instructions which, when executed on the computing device, facilitate navigation instructions to be displayed to the user via the user interface.

5. The computer-implemented method of claim 3 further including a step of determining a point-of-interest that is along the route.

6. The computer-implemented method of claim 5 further including a step of transmitting instructions which, when executed on the computing device, facilitate identification of the point-of-interest to the user via the user interface.

7. The computer-implemented method of claim 1 further including a step of collecting a profile for the user, the user profile including data that is descriptive of the user.

8. The computer-implemented method of claim 7 in which the data comprises socio-demographic data.

9. The computer-implemented method of claim 7 in which the data comprises user preferences.

10. A computer-implemented method performed on a computing device for providing a location-based service to a user of the computing device, the method comprising the steps of:
implementing a user interface configured for receiving user input indicating at least a destination within a service area supported by the location-based service, the location-based service being divided into a plurality of mapped communities;
sending a location of the user within one of the mapped communities;
displaying a route to the destination through the user interface;
displaying information about one or more businesses or points-of-interest along the route to the user via the user interface, the information including blogs and tweets, the displaying being performed responsively to a proximity of the user to the one or more businesses or points-of-interest, the proximity being user-selectable through the user interface; and
configuring the user interface to receive comments about the businesses or points-of-interest, the comments being arranged for display to other users of the location-based services.

11. The computer-implemented method of claim 10 further including a step of displaying advertising and promotional information from a business.

12. One or more computer-readable storage media containing instructions which, when executed by one or more processors on an electronic device, perform a method for implementing a location-based service, the method comprising the steps of:
providing a web-based facility for collecting data from a plurality of businesses, the data including locations of the businesses within a service area and descriptions of the businesses, the collecting being performed on an individual business-by-business basis, the descriptions including at least a name of the businesses;
configuring the web-based facility for collecting at least one of advertising, offers, and promotional information provided by businesses; and
providing the collected data and the least one of advertising, offers, and promotional materials for delivery to a remote device, the remote device having a user interface for displaying the collected data and advertising and promotional materials to a user as the user traverses a route along a path in a mapped community within the service area, the route being dynamically displayed on the device, the delivery being performed responsively to the user's proximity to a location of a given business within the service area, the proximity being user-settable through the user interface.

13. The one or more computer-readable storage media of claim 12 in which the method further includes a step of configuring the web-based facility for collecting blogs and tweets provided by businesses.

14. The one or more computer-readable storage media of claim 13 in which the method further includes a step of providing the collected blogs and tweets for delivery to a remote device and display to the user via the user interface.

15. The one or more computer-readable storage media of claim 12 comprising a further step of providing a mapped route to the user and dynamically displaying the user's location along the mapped route.

16. The one or more computer-readable storage media of claim 12 comprising a further step of collecting user data that describes users' behavior when using the remote device.

17. The one or more computer-readable storage media of claim 12 comprising a further steps of analyzing and sending the collected user data to one or more of the businesses within the service area.

18. The one or more computer-readable storage media of claim 17 comprising a further step of anonymizing the collected user data prior to sending the data.

19. The one or more computer-readable storage media of claim 12 in which the offers are embodied as mobile coupons.

20. The one or more computer-readable storage media of claim 12 comprising a further step of collecting utilization data that describes users' utilization of the advertising, offers, and promotional information.

21. The one or more computer-readable storage media of claim 12 comprising a further step of sending the collected utilization data to one or more of the businesses within the service area.

22. The one or more computer-readable storage media of claim 12 comprising a further step of sending a notice to a business within the service area when the user is within proximity of the business.

23. An application (app) configured to operate on a computing platform including a smartphone, the app being implemented through execution of computer-readable code stored on the computing platform, the app performing a method comprising the steps of:
exposing, to an app user, a user interface configured for receiving user input and for graphically displaying a map of a service area supported by a location-based service, the location-based service being divided into a plurality of mapped communities;
sending a location of the user within one of the mapped communities to the location-based service;
displaying the user's location on the user interface, the location displaying being dynamic so that the user's location is updated on the map as the user moves throughout the mapped community; and
displaying data pertaining to one or more businesses or points-of-interest in the mapped community to the user via the user interface, the information including one or more of mobile coupons, offers, information, recommendations, descriptions, menus, reviews, comments, blogs, or tweets, the displaying being performed responsively to a proximity of the user to the one or more businesses or points-of-interest, the proximity being user-selectable through the user interface.

24. The app of claim 23 in which the method further includes a step of configuring the user interface to enable the app user to make reservations at a restaurant within the mapped community.

25. The app of claim 23 in which the method further includes a step of enabling the app user to redeem a mobile coupon through the user interface at a business within the mapped community.

26. The app of claim 23 in which the method further includes the steps of collecting preferences of the app user through the user interface and displaying the data pertaining to one or more businesses or points-of-interest in the mapped community responsively to the user preferences.

27. The app of claim 23 in which the method further includes the steps of collecting usage data pertaining to the app user's use of the app and displaying the data pertaining to one or more businesses or points-of-interest in the mapped community responsively to the usage data.

28. The app of claim 23 in which the method further includes the steps of collecting behavior data pertaining to the app user's behavior within the mapped community and displaying the data pertaining to one or more businesses or points-of-interest in the mapped community responsively to the behavior data.

29. The app of claim 23 in which the method further includes a step of configuring the user interface to receive comments from the app user about the businesses or points-of-interest, the comments being arranged for display to other users of the location-based service.

30. The app of claim 23 in which the method further includes a step of displaying the data pertaining to one or more businesses or points-of-interest in the mapped community responsively to a time of day.

31. The app of claim 23 in which the method further includes a step of displaying the data pertaining to one or more businesses or points-of-interest in the mapped community responsively to one or more characteristics of the app user.

32. The app of claim 31 in which the one or more characteristics include the app user's gender, social graph, clothing size, or socio-demographic category.
